(19) United States
(12) Patent Application Publication
(10) Pub. No.: US 2008/0164357 A1
(43) Pub. Date: Jul. 10, 2008

(54) HAND-PULLING FOOD CUTTER/MIXER

(76) Inventors: Mei Ying Chau, Chai Wan (HK); Shek Lun Fok, Chai Wan (HK)

Correspondence Address: RABIN & Berdo, PC, 1101 14TH STREET, NW, SUITE 500, WASHINGTON, DC, 20005, US

(21) Appl. No.: 11/872,159

(22) Filed: Oct. 15, 2007

(30) Foreign Application Priority Data
Jan. 8, 2007 (CN) 200720001836.9

(51) Int. Cl. B02C 18/30

(52) U.S. Cl. 241/285.2

(57) ABSTRACT

The present utility model provides a hand-pulling food cutter/mixer, which comprises a container, a lid on the container and a processing implement in the container, and is characterized in that a hand-pulling driving mechanism is fixed into the lid, and comprises a torque-receiving device, a driving device and a torsional spring group one end of which is fixed to said upper lid and the other end of which is fixed to the driving device having a cord with a pull handle and a hollow drive gear the inner side of which has supporting teeth, the lower part of the torque-receiving device is a upright axis and the upper part of the torque-receiving device is a cob from the circumference of which at least two elastic arms, the end of each of which has a protruding end, extends symmetrically and oppositely, the upper part of the torque-receiving device is positioned in the hollow part of the drive gear, each of the protruding ends of the elastic arms is positioned between two of said supporting teeth, the upper part of the processing implement is positioned around the upright axis of the torque-receiving device. The present utility model has a low production cost, saves energy, and is safe and convenient to use.

### FIELD OF TECHNOLOGY

The present utility model relates to food cutters/mixers, in particular, to one hand-pulling food cutter/mixer.

### DESCRIPTION OF RELATED ARTS

The existing food cutters or mixers break food into pieces mainly through cutting food by rotating blades driven mostly by power. Each comprises a food container, a container base for fixing the food container, and the container base is fixed on the machine body having an electromotor which is usually a high-speed electromotor. For example, the Chinese patent (patent application number: 200480000127.8) described that a hand-holding mixer for mixing and processing more or less liquid food in a container comprised a rod-like component one end of which had a tool-fixing piece suitable for fixing different tools, such as cutting tools, mincing tools or mixing pieces, inserting downward into the container, and further comprised an electromotor for driving the tools fixed by the tool-fixing piece, and the characteristics of the invention were that the electromotor of the driving mechanism was a high-speed electromotor whose maximum rotating speed was at least 20000 rpm, and a part of an unit including a gear mechanism through which the maximum rotating speed could be decreased to a speed suitable to the tools used. This kind of food cutter or mixer has a relatively complicated construction and a high production cost, and should be used where the electricity is available, moreover, it has a high energy consumption and a certain hidden trouble of safety, and produces very high noises. In order to solve the above-mentioned existing problems and defects, it is necessary to improve the existing food cutters or mixers.

### SUMMARY OF THE PRESENT UTILITY MODEL

The present utility model is to overcome the above-mentioned defects existed in the prior arts, to provide one hand-pulling food cutter/mixer which has a low production cost, saves energy, and is safe and convenient.

To achieve the above-mentioned aim, the hand-pulling food cutter/mixer of the present utility model is carried out according to the following methods: the features of the hand-pulling food cutter/mixer comprising a container, a lid on the container and a processing implement in the container are that the lid comprises an upper lid the underside surface of which has a downward shaft, and a hand-pulling driving mechanism fixed to the upper lid and positioned around the shaft, and the lower part of the hand-pulling driving mechanism has a protruding upright axis around which the processing implement is positioned.

The hand-pulling driving mechanism comprises a torsional spring group one end of which is fixed to the upper lid, a driving device, to which the other end of the torsional spring group is fixed, comprising a hand-pulling force-applying piece and a drive gear, a torque-receiving device the upper part of which is a force-receiving part around which the drive gear is positioned and the lower part of which is the upright axis, and a supporting cover through which the upright axis extends.

The inner side of the drive gear has supporting teeth, and the force-receiving part comprises at least two elastic arms, the end of each of which has a protruding end positioned between two of the supporting teeth, extending symmetrically and oppositely from the circumference of a cob.

The hand-pulling force-applying piece has an upper disk plate and a lower disk plate both of which have a same short axis coiled by a cord the outer end of which has a pull handle, and the side of the supporting cover has a slot through which the cord passes, and the surface of the upper lid has a small hole through which the cord extends and outside of which the pull handle is positioned.

The torsional spring group is composed of several layers of coaxial spring loops formed by coiling a spring from inside to outside along a certain direction, and the two inside and outside ends of the torsional spring group are curved to form opposite inside and outside hooks, and the inner surface of the upper lid has an annular ring having an opening caught by the outside hook, the upper part of the driving device has a small column caught by the inside hook.

The underside surface of the upper lid has several column apertures, and the hand-pulling driving mechanism has column holes corresponding to the column apertures, bolts are screwed into the column apertures and the column holes to secure the supporting cover to the upper lid.

The bottom center within the container has a small protuberance, and the lower part of the processing implement is positioned around the protuberance.

The beneficial effects of the present utility model are that:

1. Driven manually, the present utility model is just composed of the lid, the container and the blade assembly, and has a simple structure, a convenient production art and a low production cost. For the blade assembly of the present utility model can be replaced by a stirrer, it can serve not only as a food cutter but also a food mixer, which saves materials greatly.

2. Driven manually, the present utility model has an increased safety factor and a lower noise while saving energy.

3. Driven manually, the present utility model is not restricted by the environment, and is easy to use.

4. That the present utility model can be used not only as a food cutter but also a food mixer makes it convenient to use.

### BRIEF DESCRIPTION OF THE DRAWINGS

FIG. 1 is a schematic isometric view of an embodiment of the present utility model.

FIG. 2 is one of the exploded views of an embodiment of the present utility model.

FIG. 3 is another of the exploded views of an embodiment of the present utility model.

FIG. 4 is a schematic isometric view of an embodiment of the present utility model in use.

FIG. 5 is a schematic view of the state of the drive gear and the torque-receiving device when an embodiment of the present utility model is in use.

FIG. 6 is a schematic view of the state of the drive gear and the torque-receiving device after an embodiment of the present utility model is used.

### DETAILED DESCRIPTION OF THE PREFERRED EMBODIMENT

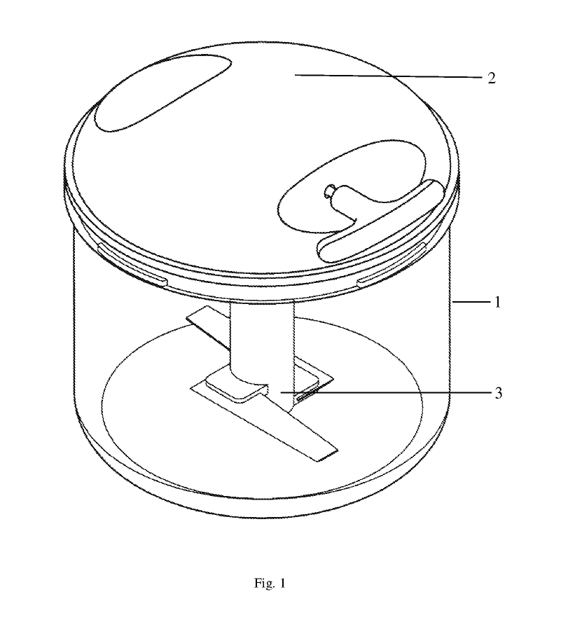

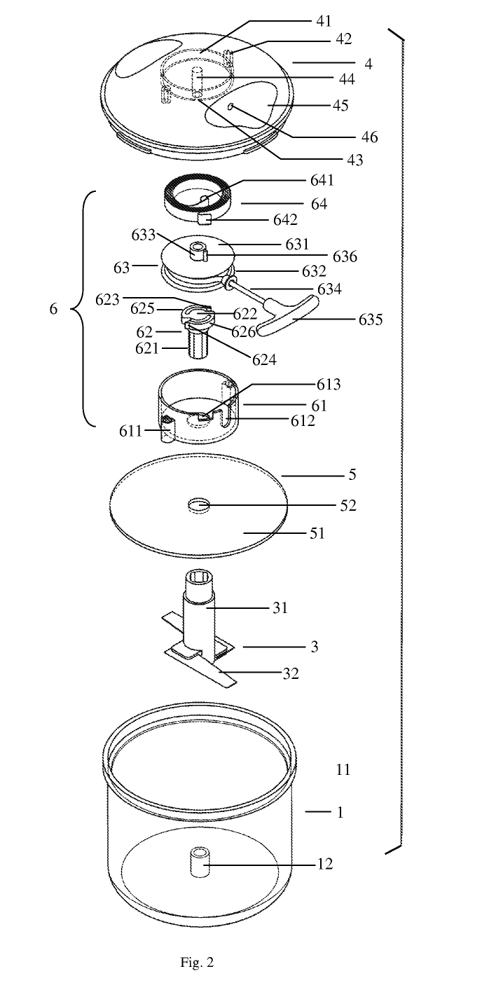

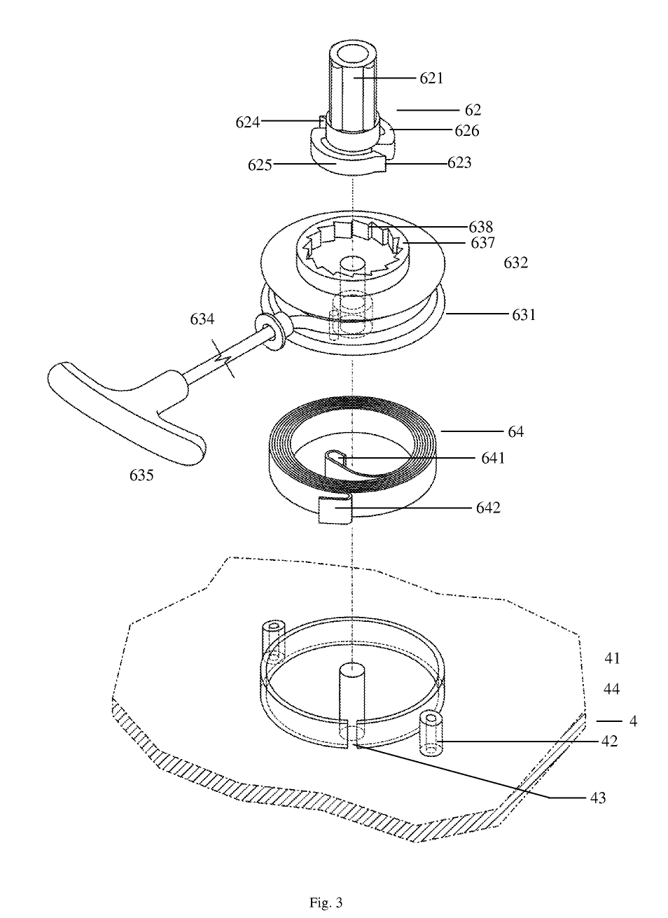

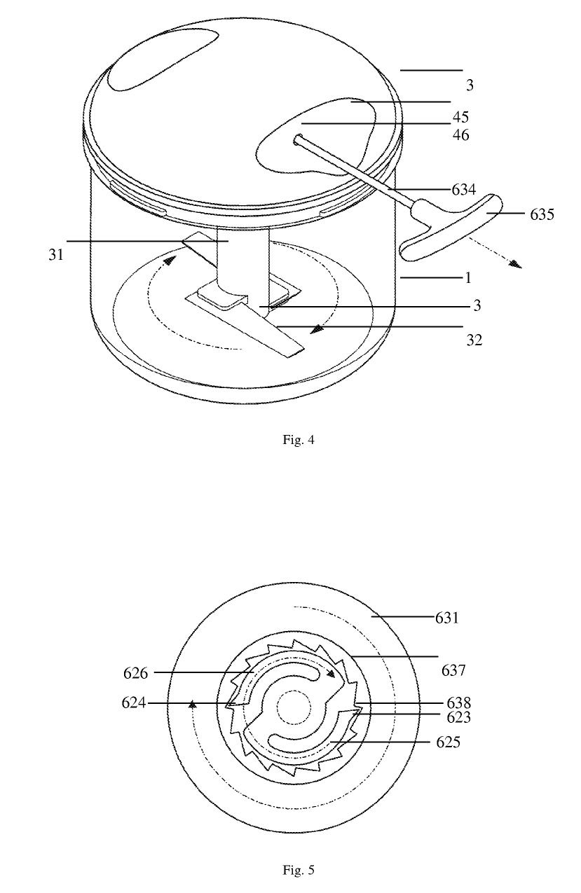

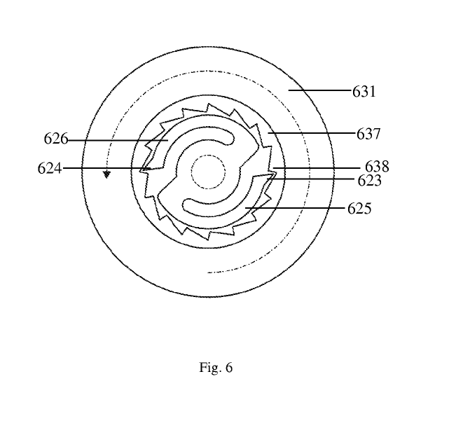

In order to understand the technical content of the present utility model more clearly, please refer to FIG. 1˜FIG. 6.

To overcome the shortcomings of the prior arts, the hand-pulling food cutter/mixer of the present utility model comprises a container 1, a lid 2 on the container 1 and a blade assembly 3 in the container 1, wherein:

The lid 2 comprises an upper lid 4, a lower lid 5 and a hand-pulling driving mechanism 6 which is between the upper lid 4 and the lower lid 5 and fixed to the upper lid 4.

The upper lid 4 is a disk protruding upwardly slightly, and its underside surface has an annular ring 41 protruding downwardly outside which there are two column apertures into which bolts can be screwed. The annular ring 41 has an opening 43, and the center of the annular ring 41 has a downward shaft 44, the upper surface of the upper lid 4 has symmetrical recesses 45 to be caught easily by hands to apply force conveniently. One of the recesses 45 has a small hole 46. The number of the column apertures 42 can also be more than two.

The hand-pulling driving mechanism 6 comprises a supporting cover 61, a torque-receiving device 62, a driving device 63 and a stainless steel spring group 64.

The stainless steel spring group 64 is composed of several layers of coaxial spring loops formed by coiling a flat spring clockwise from inside to outside, and the two inside and outside ends of the stainless steel spring group 64 are curved to form opposite inside and outside hooks 641, 642.

The structure of the driving device 63 is that: it has an upper disk plate 631 and a lower disk plate 632 both of which have a same hollow short axis 633 one end of which protrudes above the upper disk plate 631, the short axis 633 can be positioned around the shaft 44, a cord 634 is coiled anticlockwise from inside to outside around the short axis 633 between the upper disk plate 631 and the lower disk plate 632, the outer end of the cord 634 has a pull handle 635, beside the cylindrical part of the short axis 633 protruding above the upper disk plate 631 are a small column 636. The stainless steel spring group 64 and the driving device 63 are positioned around the shaft 44 such that the inside hook 641 can catch the small column 636 and the outside hook 642 can catch the opening 43 of the annular ring 41. The bottom of the lower disk plate 632 has a round hollow drive gear 637 the hollow part of which is bigger than the cross section of the short axis 633, and the inner side of the drive gear 637 has supporting teeth 638. The drive gear 637 can also be round, rectangular, polygonal or other suitable figures.

The lower part of the torque-receiving device 62 is a round axis 621 the outside of which has projecting ridges, and the round axis 621 can also be polygonal or other suitable figures for fixing the shaft positioned around it. The upper part of the torque-receiving device 62 is a cob 622 which is slightly bigger than the round axis and integrates with the round axis 621. Two elastic arms 625, 626 having protruding ends 623, 624 respectively extend symmetrically and in the same direction (clockwise) from the circumference of the cob 622. The upper part of the torque-receiving device 62 is positioned in the hollow part of the drive gear 637 such that each of the protruding ends 623, 624 of the elastic arms 625, 626 is nicely positioned between two supporting teeth 638 of the drive gear 637.

The coiling direction of the stainless steel spring group 64 can also be anticlockwise from inside to outside, then the cord should be clockwise from inside to outside, and the directions of the two elastic arms 625, 626 are anticlockwise. The number of the elastic arms can also be more than two.

Corresponding to the annular ring 41 on the inner surface of the upper lid 4, the supporting cover 61 is formed by a disk whose circumference extends upwards a certain height. The supporting cover 61 has two column holes 611 corresponding to the column apertures 42, thus bolts can be screwed into the column holes 611 and the column apertures 42 to secure the supporting cover 61 to the upper lid 41. The side of the supporting cover 61 has a slot 612 through which passes the cord 634 extending through the small hole 46 of the upper lid 4, and the pull handle is positioned outside of the small hole 46. The bottom center of the supporting cover 61 has a hole 613 through which the round axis 621 of the lower part of the torque-receiving device 62 passes.

Corresponding to the upper lid 4, the lower lid 5 is a disk 51 protruding downwardly slightly the circumference of which can be secured to the upper lid 4, and the bottom center of the disk has a circular hole 52 through which the round axis 621 of the lower part of the torque-receiving device 62 passes.

The blade assembly 3 includes a hollow blade shaft 31 and stainless steel cutting blades 32 horizontally fixed to the blade shaft 31. The figure of the hollow part is corresponding to the figure of the round axis 621 of the lower part of the torque-receiving device 62 and can be positioned around the round axis 621 such that when the round axis 621 rotates, the blade assembly 3 will rotate consequently. Of course, the stainless steel cutting blades 32 can be replaced by spatulas and other cutters.

The size of the container 1 is corresponding to that of the lid 2 and has a concave cavity 11 for placing food to be cut, the bottom center has a small protuberance 12 which can be a cylinder or other suitable figures such as a cone and can be surrounded by the hollow lower part of the blade shaft 31 without counteracting the rotation of the blade shaft 31. So the main role of the small protuberance 12 is to support the blade shaft 31 not to be punch-drunk when impacted by the food to prevent the blade shaft 31 even the round axis 621 from breaking.

When there is some food to be cut, open the lid 2, place the food to be cut into the container 1, align the round axis 621 with the blade shaft 31 of the blade assembly 3, put the lid 2 on the container, and pull the pull handle 635 which drives the short axis 633 and the drive gear 637 correspondingly, then the drive gear 637 applies the force to the protruding ends 623, 624 of the two elastic arms 625, 626 of the upper part of the torque-receiving device 62 to drive the round axis 621 of the lower part of the torque-receiving device 62 to rotate the blade assembly 3 to achieve the cutting of the food. During the cutting of the food, the blade assembly 3 would receive some resistance and transfer the resistance to the round axis 621 which would transfer the resistance to the two elastic arms 625, 626, thus under the two forces of the driving force from the drive gear 637 and the resistance from the food, the two elastic arms 625, 626 would bend outwards slightly. When it is difficult to cut the food and the resistance is relatively big, the two elastic arms 625, 626 would bend outwards further, and when the two elastic arms 625, 626 bend outwards too much, the two elastic arms 625, 626 would be propped against the two or more supporting teeth 638 on the inner side of the drive gear 637, and the supporting teeth 638 can prevent the two elastic arms 625, 626 from bending outwards too much which could result in fracture.

Meanwhile, as the pulling of the pull handle 635 drives the short axis 633, it would also drive the small column 636 to drive the hook 641 of the stainless steel spring group 64 catching the small column 636 to further cause the stainless steel spring group 64 to coil at a smaller circumference such that the stainless steel spring group 64 produces an elasticity for returning to the original position.

When the cutting finishes, unlash the pull handle 635, then the elasticity for returning to the original position produced by the stainless steel spring group 64 drives the small column 636 to go back to its original position, then to drive the cord 634 and the pull handle 635 to return to their original positions. Therefore, the two elastic arms 625, 626 of the torque-receiving device 62 are released from the contact state of the torque-receiving device 62 with the drive gear 637 having the supporting teeth 638 on the inner side.

When the blade assembly 3 of the hand-pulling food cutter/mixer of the present utility model is replaced by a stirrer, it can be used to mix eggs or other mushy food, and the blade assembly 3 can also be replaced by other suitable processing implements such as a mixing basket.

The present utility model has a simple structure, a convenient production art and a low production cost. That the present utility model can be serve not only as a food cutter but also a food mixer saves materials greatly. Driven manually, while saving energy, the present utility model has an increased safety factor and a lower noise, and is not restricted by the environment, and is easy to use. That the present utility model can be used not only as a food cutter but also a food mixer makes it convenient to use.

It should be noted that the present utility model has been described referring to the particular embodiment. But it is obvious that one skilled in the art can change or modify the present utility model without departure from the spirit and scope of the present utility model. Therefore the specification and the drawings are exemplary only and not intended to be limiting.

What is claimed is:

1. A hand-pulling food cutter/mixer, comprising a container, a lid on said container and a processing implement in said container, characterized in that said lid comprises an upper lid the underside surface of which has a downward shaft, and a hand-pulling driving mechanism fixed to said upper lid and positioned around said shaft, and the lower part of said hand-pulling driving mechanism has a protruding upright axis around which the processing implement is positioned.

2. A hand-pulling food cutter/mixer according to claim 1, characterized in that said hand-pulling driving mechanism comprises a torsional spring group one end of which is fixed to said upper lid, a driving device, to which the other end of said torsional spring group is fixed, comprising a hand-pulling force-applying piece and a drive gear, a torque-receiving device the upper part of which is a force-receiving part around which the drive gear is positioned and the lower part of which is said upright axis, and a supporting cover through which said upright axis extends.

3. A hand-pulling food cutter/mixer according to claim 2, characterized in that said inner side of said drive gear has supporting teeth, and said force-receiving part comprises at least two elastic arms, the end of each of which has a protruding end positioned between two of said supporting teeth, extending symmetrically and oppositely from the circumference of a cob.

4. A hand-pulling food cutter/mixer according to claim 2, characterized in that said hand-pulling force-applying piece has an upper disk plate and a lower disk plate both of which have a same short axis coiled by a cord the outer end of which has a pull handle, and the side of said supporting cover has a slot through which said cord passes, and the surface of the upper lid has a small hole through which the cord extends and outside of which said pull handle is positioned.

5. A hand-pulling food cutter/mixer according to claim 2, characterized in that said torsional spring group is composed of several layers of coaxial spring loops formed by coiling a spring from inside to outside along a certain direction, and the two inside and outside ends of said the torsional spring group are curved to form opposite inside and outside hooks, and the inner surface of said upper lid has an annular ring having an opening caught by said outside hook, the upper part of said driving device has a small column caught by said inside hook.

6. A hand-pulling food cutter/mixer according to claim 4, characterized in that said torsional spring group is composed of several layers of coaxial spring loops formed by coiling a spring from inside to outside along a certain direction, and the two inside and outside ends of said the torsional spring group are curved to form opposite inside and outside hooks, and the inner surface of said upper lid has an annular ring having an opening caught by said outside hook, the upper part of said driving device has a small column caught by said inside hook.

7. A hand-pulling food cutter/mixer according to claim 1, characterized in that the underside surface of said upper lid has several column apertures, and said hand-pulling driving mechanism has column holes corresponding to said column apertures, bolts are screwed into said column apertures and said column holes to secure said supporting cover to said upper lid.

8. A hand-pulling food cutter/mixer according to claim 1, characterized in that the bottom center within said container has a small protuberance, and the lower part of said processing implement is positioned around said protuberance.

9. A hand-pulling food cutter/mixer according to claim 3, characterized in that said hand-pulling force-applying piece has an upper disk plate and a lower disk plate both of which have a same short axis coiled by a cord the outer end of which has a pull handle, and the side of said supporting cover has a slot through which said cord passes, and the surface of the upper lid has a small hole through which the cord extends and outside of which said pull handle is positioned.

10. A hand-pulling food cutter/mixer according to claim 3, characterized in that said torsional spring group is composed of several layers of coaxial spring loops formed by coiling a spring from inside to outside along a certain direction, and the two inside and outside ends of said the torsional spring group are curved to form opposite inside and outside hooks, and the inner surface of said upper lid has an annular ring having an opening caught by said outside hook, the upper part of said driving device has a small column caught by said inside hook.

11. A hand-pulling food cutter/mixer according to claim 9, characterized in that said torsional spring group is composed of several layers of coaxial spring loops formed by coiling a spring from inside to outside along a certain direction, and the two inside and outside ends of said the torsional spring group are curved to form opposite inside and outside hooks, and the inner surface of said upper lid has an annular ring having an opening caught by said outside hook, the upper part of said driving device has a small column caught by said inside hook.
